(19) United States
(12) Patent Application Publication
(10) Pub. No.: US 2025/0350524 A1
(43) Pub. Date: Nov. 13, 2025

(54) TRANSMISSION DEVICE AND TRANSMISSION METHOD FOR TRANSMITTING DATA BY USING CARRIER SIGNAL

(71) Applicant: KYUNGPOOK NATIONAL UNIVERSITY INDUSTRY-ACADEMIC COOPERATION FOUNDATION, Daegu (KR)

(72) Inventor: Dongseog HAN, Daegu (KR)

(21) Appl. No.: 18/996,419

(22) PCT Filed: Aug. 10, 2023
(86) PCT No.: PCT/KR2023/011810

§ 371 Date: Jan. 17, 2025

(30) Foreign Application Priority Data
Aug. 12, 2022 (KR) 10-2022-0101605

(51) Int. Cl. H04L 27/26

(52) U.S. Cl. CPC H04L 27/2628

(57) ABSTRACT

The present disclosure relates to a transmission device for transmitting data by using a carrier signal, comprising: a receptor for receiving a plurality of pieces of data from an antenna; a mapping processor which selects any one or more pieces of data from the plurality of pieces of data so as to confirm the value and the order of the corresponding data, and which maps order information of the data to a carrier present in an order that is the same as the value; and a modulator for modulating the carrier into a transmission signal. Therefore, data transmission efficiency can be improved.

### TECHNICAL FIELD

The present invention relates to a transmission device and a transmission method for transmitting data using a carrier signal, and more specifically, a transmission device and a transmission method for transmitting data that uses a carrier signal which modulates and transmits data on the carrier signal.

### BACKGROUND ART

Wireless communication systems are widely deployed in various fields to wirelessly transmit and receive various data such as voice, image, and video.

These wireless communication systems are multiple access systems that may support communications with multiple users by sharing available system resources (bandwidth, transmission power, and the like).

Accordingly, wireless communication systems mainly use Code Division Multiple Access (CDMA) systems, Frequency Division Multiple Access (FDMA) systems, Time Division Multiple Access (TDMA) systems, Orthogonal Frequency Division Multiple Access (OFDMA) systems, Single Carrier Frequency Division Multiple Access (SC-FDMA) systems, or the like.

In addition, wireless communication systems use one bandwidth for data transmission.

For example, second generation wireless communication systems use a bandwidth of 200 KHz to 1.25 MHz, and third generation wireless communication systems use a bandwidth of 5 MHz to 10 MHz.

In addition, recent 3GPP LTE or 802.16m tends to increase the bandwidth to 20 MHz or higher.

Although increasing the bandwidth is essential to increase the transmission capacity in these wireless communication systems, supporting a large bandwidth even when the level of required service is low has a problem of causing a lot of power consumption.

Accordingly, for the wireless communication systems, a main carrier having one bandwidth and a center frequency is defined, and multi-carrier systems that transmit and receive data in a wideband through a plurality of carriers are developed.

However, multi-carrier systems have a problem in that interference frequently occurs between carriers when the number of carriers increases, and they are vulnerable to external noise signals in the process of transmitting and receiving information on the carriers.

Accordingly, a transmission device for transmitting and receiving data in a multi-carrier system that performs wireless communications is required.

### PRIOR ART DOCUMENTS

### Patent Documents

(Patent Document 1) (Republic of Korea) Patent Publication No. 10-2002-0068374

### DISCLOSURE OF INVENTION

### Technical Problem

Therefore, the present invention has been made in view of the above problems, and the goal of the present invention is to provide a transmission device and a transmission method for transmitting data using a carrier signal that modulates the data into a transmission signal by mapping the data to a carrier.

### Technical Solution

To accomplish the above object, according to one aspect of the present invention, a transmission device for transmitting data using a plurality of carrier signals, the device comprising: a reception unit for receiving a plurality of data from an antenna; a mapping unit for selecting any one or more of data among the plurality of data, confirming a value and a sequence of the data, and mapping the sequence information of the data to a carrier existing in a sequence the same as that of the value; and a modulation unit for modulating the carrier into a transmission signal.

In relation thereto, when there are data having the same value among the plurality of data, the mapping unit may map the sequence information of any one of data having the same value to a carrier existing in a first sequence.

In addition, the modulation unit may modulate the carrier into a transmission signal by performing inverse fast Fourier transform (IFFT).

According to another aspect of the present invention, there is provided a transmission method performed in a transmission device for transmitting data using a plurality of carrier signals, the method comprising: a receiving step of receiving a plurality of data from an antenna; a mapping step of selecting any one or more of data among the plurality of data, confirming a value and a sequence of the data, and mapping sequence information of the data to a carrier existing in a sequence the same as that of the value; and a modulation step of modulating the carrier into a transmission signal.

In relation thereto, when there are data having the same value among the plurality of data, the mapping step may map the sequence information of any one of data having the same value to a carrier existing in a first sequence.

In addition, the modulation step may modulate the carrier into a transmission signal by performing inverse fast Fourier transform (IFFT).

### Advantageous Effects

According to an aspect of the present invention described above, data transmission efficiency can be enhanced by providing the transmission device and transmission method that transmit data using the carrier signal.

### BRIEF DESCRIPTION OF THE DRAWINGS

FIG. 1 is an exemplary view showing a multi-carrier system including a transmission device that transmits data using a carrier signal according to an embodiment of the present invention.

FIG. 2 is a block diagram showing a transmission device that transmits data using a carrier signal according to an embodiment of the present invention.

FIG. 3 is a detailed block diagram showing the transmission device in FIG. 2.

FIG. 4 is an exemplary view showing a first constellation used by the transmission device in FIG. 2.

FIG. 5 is an exemplary view showing a second constellation used by the transmission device in FIG. 2.

FIG. 6 is an exemplary view showing a plurality of carriers that the modulation unit in FIG. 2 receives.

FIG. 7 is a flowchart illustrating a transmission method according to an embodiment of the present invention.

### BEST MODE FOR CARRYING OUT THE INVENTION

The detailed description of the present invention described below refers to the accompanying drawings that show specific embodiments in which the present invention can be practiced as an example. These embodiments are described in detail to be sufficient for those skilled in the art to practice the present invention. It should be understood that various embodiments of the present invention do not necessarily need to be mutually exclusive although they are different from each other. For example, the specific shapes, structures, and characteristics described herein may be implemented in other embodiments without departing from the character and scope of the present invention with respect to an embodiment.

In addition, it should also be understood that the location or arrangement of individual components within each disclosed embodiment may be changed without departing from the character and scope of the present invention. Accordingly, it is not intended to take the detailed description described below in a limiting sense, and the scope of the present invention is defined only by the appended claims, together with all the scopes equivalent to that the claims assert, if properly described. Like reference numerals in the drawings designate the same or similar features throughout the several aspects.

In addition, the features and advantages of the present invention will become more clear from the detailed descriptions based on the accompanying drawings, and the terms or words used in this specification and claims should not be interpreted in the usual or dictionary meanings, but should be interpreted in the meanings and concepts that conform to the technical character of the present invention on the basis of the principles that the inventors may appropriately define the concepts of the terms in order to explain their own invention in the best way.

Hereinafter, preferred embodiments of the present invention will be described in more detail with reference to the drawings.

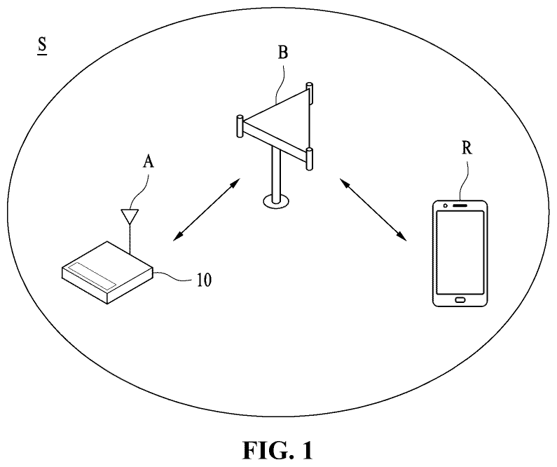

FIG. 1 is an exemplary view showing a multi-carrier system including a transmission device that transmits data using a carrier signal according to an embodiment of the present invention.

A multi-carrier system S that includes transmission device 10 which transmits data using a carrier signal according to an embodiment of the present invention may be used in various wireless transmission systems such as Orthogonal Frequency Division Multiple Access (OFDMA), Single Carrier Frequency Division Multiple Access (SC-FDMA), Quadrature Amplitude Modulation (QAM), and the like.

Here, OFDMA is a technique implemented using wireless techniques such as IEEE 802.11 (Wi-Fi), IEEE 802.16 (WiMAX), IEEE 802-20, E-UTRA (Evolved UTRA), and the like. Here, UTRA is a part of a Universal Mobile Telecommunications System (UMTS).

In addition, long-term evolution (LTE) of the 3rd Generation Partnership Project (3GPP) is a technique that adopts OFDMA in downlink and SC-FDMA in uplink as part of Evolved UMTS (E-UMTS) that uses E-UTRA.

Therefore, although the multi-carrier system S is described as an OFDM transmission method that modulates in a QAM modulation technique for easy explanation of the present invention, it is not limited thereto.

Referring to FIG. 1, the multi-carrier system S includes a transmission device 10 (hereinafter, “transmission device”) that transmits data using a carrier signal, a terminal R, and a base station B.

The base station B may be prepared to provide communication services for a specific geographic region (generally referred to as a cell). Here, the cell may be divided into a plurality of regions.

The base station B may be generally set as a fixed station that communicates with the transmission device 10 and the terminal R or may be a communication facility referred to as evolved-NodeB (eNB), Base Transceiver System (BTS), Access Point, or the like.

The terminal R may be provided to receive data or transmission signals from the base station B.

Here, the terminal R is a device that actually receives data and transmission signals from the transmission device 10, and may be fixed or mobile.

The terminal R may be provided as a mobile station (MS), a user terminal (UT), a subscriber station (SS), a wireless device, a personal digital assistant (PDA), a wireless modem, a handheld device, or the like.

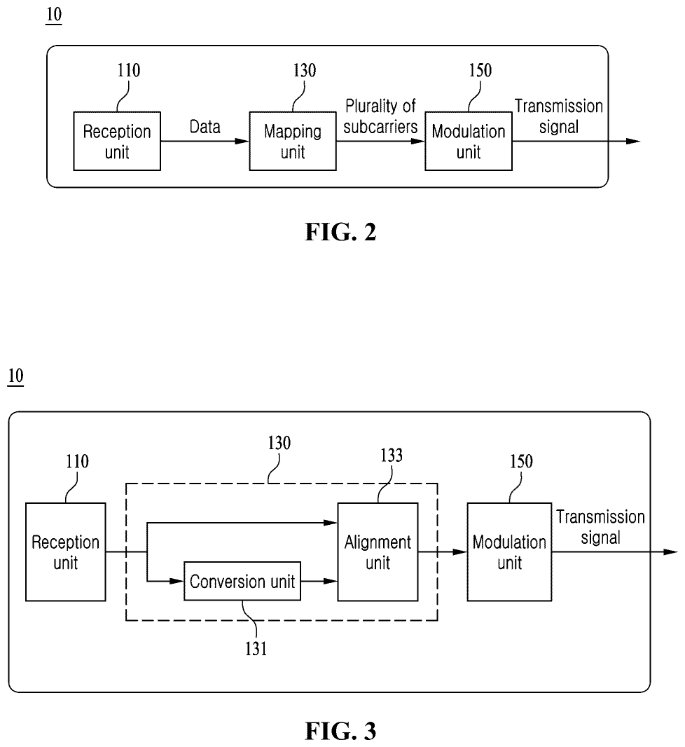

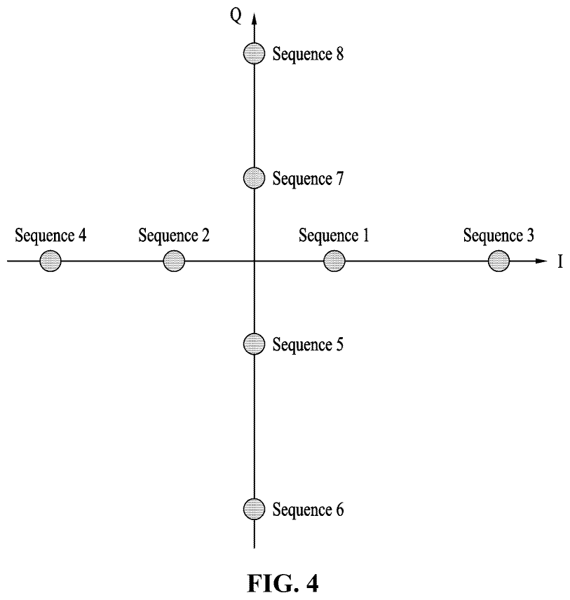

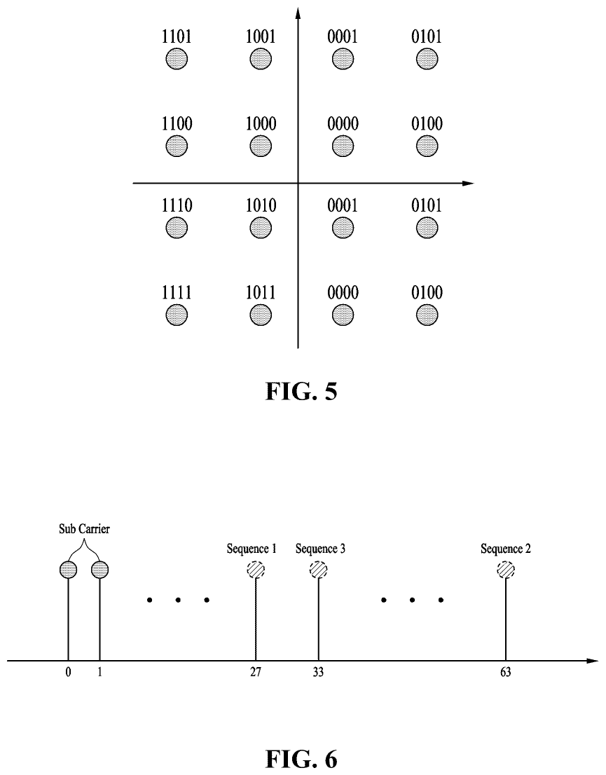

FIG. 2 is a block diagram showing a transmission device that transmits data using a carrier signal according to an embodiment of the present invention, FIG. 3 is a detailed block diagram showing the transmission device in FIG. 2, FIG. 4 is an exemplary view showing a first constellation used by the transmission device in FIG. 2, FIG. 5 is an exemplary view showing a second constellation used by the transmission device in FIG. 2, and FIG. 6 is an exemplary view showing a plurality of carriers that the modulation unit in FIG. 2 receives.

The transmission device 10 is provided to modulate a plurality of data received by communicating with the base station B into a transmission signal.

The transmission device 10 may be mobile or fixed. The transmission device 10 may be in the form of a server or an engine, and may be referred to as another term such as an apparatus, a terminal, a user equipment (UE), a mobile station (MS), a wireless device, a handheld device, or the like.

In addition, the transmission device 10 may execute or produce various software based on the Operating System (OS), i.e., the system. The operating system is a system program that allows the software to use the hardware of the device, and may include all of mobile computer operating systems such as Android OS, iOS, Windows Mobile OS, Bada OS, Symbian OS, Blackberry OS, and the like, as well as computer operating systems such as Windows series, Linux series, Unix series, MAC, AIX, HP-UX operating systems, and the like.

Accordingly, the transmission device 10 may be provided to include a reception unit 110, a mapping unit 130, and a modulation unit 150 to perform a transmission method of modulating and transmitting data.

In addition, the transmission device 10 may install and execute software (applications) for performing the transmission method, and the reception unit 110, the mapping unit 130, and the modulation unit 150 may be controlled by the software for performing the transmission method performed by the transmission device 10.

In addition, the transmission device 10 may further include, although not shown in the drawings, a storage unit in which data received from the outside and a preset constellation are stored, and a communication unit for network communication with the base station B and the terminal R, and the storage unit and the communication unit may also be controlled by the software for performing the transmission method performed by the transmission device.

In addition, the transmission device 10 may be a separate terminal or module. In addition, the reception unit 110, the mapping unit 130, and the modulation unit 150 may be formed as an integrated module or may be configured of one or more modules. However, on the contrary, each component may be formed as a separate module.

In addition, the transmission device 10 has an antenna A attached thereon to receive data from the outside through the communication unit or transmit transmission signals to the base station.

Referring to FIG. 2, the reception unit 110 receives a plurality of data from the base station B.

More specifically, the reception unit 110 may receive at least one external data from the base station B through the antenna A formed in the transmission device 10, or may receive binary data (voice, video, or the like) generated by the terminal R.

In addition, the reception unit 110 may transmit the plurality of data received through the antenna A to the mapping unit 130.

The mapping unit 130 selects any one or more of data among the plurality of data, and confirms the value and the sequence of corresponding data.

More specifically, the mapping unit 130 may confirm the value of data according to the number of carriers in OFDM having 2ⁿ sub-carriers.

For example, when performing mapping in OFDM having 64 (2⁶) carriers, the mapping unit 130 may confirm the value of data as a value of 6 bits.

In addition, when selecting any one or more of data among the plurality of data, the mapping unit 130 may confirm the sequence by selecting any one or more of data input initially.

For example, when performing mapping in OFDM having 64 (2⁶) carriers, the mapping unit 130 may perform mapping by selecting initial data, i.e., the first data, among the plurality of data as data for mapping.

In addition, the mapping unit 130 maps sequence information of the data to a carrier existing in a same sequence of the confirmed value.

More specifically, the mapping unit 130 may map the sequence information of the data to a carrier existing in a sequence the same as that of the value of the data selected among the plurality of data.

Here, as shown in FIG. 4, the mapping unit 130 may generate sequence information of the data by setting the sequence of data to a sequence number existing in a preset first constellation.

For example, when performing mapping in OFDM having 64 (2⁶) carriers, the mapping unit 130 may select the first to third data among the plurality of data and set the data as Sequences 1 to 3, and when the 6-bit value of the first data selected is 27, the 6-bit value of the second data is 63, and the 6-bit value of the third data is 33, the Sequence 1 constellation may be mapped to the carrier existing in the 27th sequence among the 63 carriers, the Sequence 2 constellation may be mapped to the carrier existing in the 63rd sequence, and the Sequence 3 constellation may be mapped to the carrier existing in the 33rd sequence.

In this way, the mapping unit 130 may select some data among the plurality of data received from the base station B, confirm the value and sequence of the data, and map sequence information of the data to a carrier the same as that of the data.

Accordingly, when there are data having the same value among the plurality of data, the mapping unit 130 may map the sequence information of any one of data having the same value to the carrier existing in the first sequence.

More specifically, when the values of any one or more of the data selected among the plurality of data are the same value, the mapping unit 130 may select one of the data having the same value and map the data to the first carrier.

For example, when performing mapping in OFDM having 64 (2⁶) carriers, the mapping unit 130 may classify duplicate data by selecting the first to fifth data among the plurality of data and sets the data as Sequences 1 to 5, mapping, when the 6-bit value of the third data and the 6-bit value of the fourth data are the same as 33, the Sequence 3 constellation to the carrier existing in the 33rd sequence among the 63 carriers, stopping carrier mapping from Sequence 4, and mapping QAM constellations in the same manner as the existing OFDM modulation method in a sequence from the first carrier that is not selected as a Sequence.

Meanwhile, referring to FIG. 3, the mapping unit 130 may further include a conversion unit 131 and an alignment unit 133.

First, the conversion unit 131 may be provided to convert data not selected by the mapping unit 130 among the plurality of data into binary data values.

More specifically, the conversion unit 131 may convert each of the data not selected by the mapping unit 130 into a binary data value.

Here, when the data is data configured of a video or an image, the conversion unit 131 may generate transposed image data by performing a transpose conversion on the pixel information included in the video or image.

Here, the image data may be data in which values of pixels constituting the image are implemented in the form of a matrix. In addition, the transposed image data may be data in which rows of the image data implemented in the form of a matrix are converted into columns, and the columns are converted into rows.

Accordingly, the conversion unit 131 may load the transpose image data in a direction corresponding to the row of the transposed image data.

More specifically, the conversion unit 131 may simultaneously load pixel information arranged in the same row in the transposed image data implemented in the form of a matrix.

Here, the direction corresponding to the transposed image may mean the direction of sequentially loading the data arranged in the same row among the data constituting the transposed image data.

Subsequently, the conversion unit 131 may perform Fourier transform on the data arranged in the same row of the transposed image data using a single instruction multiple data (SIMD) method and generate data bits corresponding to the frequency domain for the image data.

Here, the SIMD method is a method of processing multiple data simultaneously with one command, and the conversion unit 131 may group data arranged in each row among the data included in the transposed image data and perform Fourier transform on the grouped data using one command.

More specifically, the conversion unit 131 may acquire first real part data by performing Fourier transform on the transposed image data.

Here, the conversion unit 131 may further generate transposed first real part data by applying a transpose matrix operation to the first real part data, and generate data bits corresponding to the frequency domain of the image data by performing Fourier transform on the transposed first real part data.

Accordingly, when the data is configured of a video or an image, the conversion unit 131 may convert the video or image into the form of data bits through the SIMD technique and Fourier transform.

Meanwhile, when the data is configured of voice or sound, the conversion unit 131 may convert the voice or sound in the form of analog data into data bits using any one analog-frequency modulation technique among the Pulse Amplitude Modulation (PAM), Pulse Width Modulation (PWM), Pulse Position Modulation (PPM), Pulse Number Modulation (PNM), and Pulse Code Modulation (PCM).

At this point, although it is most preferable for the conversion unit 131 to use the pulse code modulation technique that converts analog data having continuous time and amplitude into digital bits in the sequence of sampling, quantizing, and encoding, it is not limited thereto as any one of the analog-frequency modulation techniques described above may be used.

In relation thereto, the mapping unit 130 may map the binary data value converted based on any one data by the conversion unit 131 to the carrier in the second constellation shown in FIG. 5.

Meanwhile, the alignment unit 133 may align the carriers in the first constellation mapped by the mapping unit 130 and the carriers in the second constellation.

Here, the alignment unit 133 may first align the carriers in the first constellation in parallel, and then align the carriers in the second constellation in parallel.

At this point, the alignment unit 133 first aligns the carriers in the first constellation because the mapping unit 130 first aligns the carriers in the first constellation in parallel by preferentially selecting the initial data, i.e., the first data, among the plurality of carriers and by mapping the data to the carriers in the first constellation, and the carriers are aligned in the first constellation.

Then, the alignment unit 133 may further consider positions of the carriers in the process of aligning the carriers in the first constellation and the carriers in the second constellation.

More specifically, the alignment unit 133 may further consider the position of a carrier set as a pilot carrier when the transmission device 10 transmits a plurality of carriers in a method related to the pilot carrier transmission defined in IEEE 802.11a, the standard of wireless LAN.

Here, the pilot carrier is a carrier used to help phase synchronization of the carrier and acquisition of information from the base station B, and it is a carrier used to separate data bits according to each data although actual data is not mapped.

Accordingly, when the position of the carrier is the position of the pilot carrier in the process of aligning the carriers in the first constellation and the carriers in the second constellation in parallel, the alignment unit 133 may align the carriers in the first constellation to the carriers in the second constellation.

The modulation unit 150 modulates the carrier into a transmission signal.

More specifically, the modulation unit 150 may modulate each of the plurality of carriers transmitted from the alignment unit 133 into a transmission signal by performing Inverse Fast Fourier Transform (IFFT).

Here, the Inverse Fast Fourier Transform is inverse transform of the Fast Fourier Transform (FFT), and the publicized Prime Factor Algorithm (PFA), Bruun's FFT Algorithm, Rader's FFT Algorithm, and Bluestein's FFT algorithm may be used.

Accordingly, the modulation unit 150 may modulate each of the plurality of carriers aligned in parallel by the alignment unit 133 into a transmission signal to be transmitted to the base station B by performing inverse fast Fourier transform thereon.

Accordingly, the transmission device 10 may improve data transmission efficiency by selecting any one or more of data among the plurality of data, confirming the value and sequence of the data, and mapping the sequence information of the data to a carrier the same as that of the confirmed value.

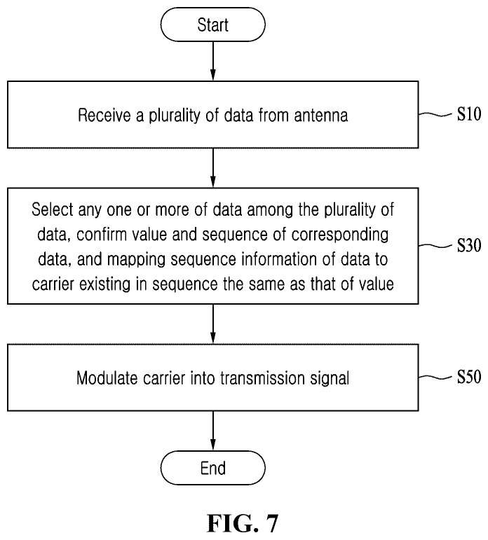

Meanwhile, FIG. 7 is a flowchart illustrating a transmission method according to an embodiment of the present invention, and since the transmission method according to an embodiment of the present invention is performed on the same configuration as the transmission device 10 shown in FIGS. 1 to 6, reference numerals the same as those of the transmission device 10 shown in FIGS. 1 to 6 are given, and repeated descriptions are omitted.

Referring to FIG. 7, a transmission method according to an embodiment of the present invention is a transmission method performed by the transmission device 10 that transmits data using a plurality of carriers, and includes a receiving step (S10), a mapping step (S30), and a modulation step (S50).

First, the transmission device 10 performs the receiving step (S10) of receiving a plurality of data from the antenna A.

Thereafter, the transmission device 10 performs the mapping step (S30) of selecting any one or more of data among the plurality of data, confirming the value and sequence of the data, and mapping sequence information of the data to a carrier existing in a sequence the same as that of the value.

Here, at the mapping step (S30), when there are data having the same value among the plurality of data, the transmission device 10 may map the sequence information of any one of the data having the same value to the carrier existing in the first sequence.

Then, the transmission device 10 performs the modulation step (S50) of modulating the carrier into a transmission signal.

At this point, at the modulation step (S50), the transmission device 10 may modulate the carrier into a transmission signal by performing Inverse Fast Fourier Transform (IFFT).

Accordingly, the transmission device 10 may improve data transmission efficiency by performing the transmission method.

Although various embodiments of the present invention have been illustrated and described above, the present invention is not limited to the specific embodiments described above, and various modifications may be made by those skilled in the art without departing from the gist of the present invention as claimed in the claims. Furthermore, such modifications should not be individually understood from the technical character or prospect of the present invention.

### DESCRIPTION OF SYMBOLS

Transmission device for transmitting data using carrier signal
110: Reception unit
130: Mapping unit
131: Conversion unit
133: Alignment unit
150: Modulation unit
A: Antenna
B: Base station
R: Terminal
S: System

1. A transmission device for transmitting data using a plurality of carrier signals, the transmission device comprising:
a receptor for receiving a plurality of data from an antenna;
a mapping processor for selecting at least one of data among the plurality of data, confirming a value and a sequence of the data, and mapping sequence information of the data to a carrier existing in a sequence the same as that of the value; and
a modulator for modulating the carrier into a transmission signal.

2. The transmission device according to claim 1, wherein when there are data having the same value among the plurality of data, the mapping processor maps the sequence information of any one of data having the same value to a carrier existing in a first sequence.

3. The transmission device according to claim 1, wherein the modulator modulates the carrier into a transmission signal by performing Inverse Fast Fourier Transform (IFFT).

4. A transmission method performed in the transmission device for transmitting data using a plurality of carrier signals, the method comprising:
a receiving step of receiving a plurality of data from an antenna;
a mapping step of selecting at least one of data among the plurality of data, confirming a value and a sequence of the data, and mapping sequence information of the data to a carrier existing in a sequence the same as that of the value; and
a modulation step of modulating the carrier into a transmission signal.

5. The transmission method according to claim 4, wherein when there are data having the same value among the plurality of data, the mapping step maps the sequence information of any one of data having the same value to a carrier existing in a first sequence.

6. The transmission method according to claim 4, wherein the modulation step modulates the carrier into a transmission signal by performing Inverse Fast Fourier Transform (IFFT).
